(19) United States
(12) Patent Application Publication
(10) Pub. No.: US 2006/0114651 A1
(43) Pub. Date: Jun. 1, 2006

(54) Laptop computer housing

(76) Inventor: Bradley Davis, Dagenham (GB)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/002,452

(22) Filed: Dec. 1, 2004

(51) Int. Cl. G06F 1/16

(52) U.S. Cl. 361/683

(57) ABSTRACT

A housing for a laptop computer has opposed front and rear panels defining a central cavity. The cavity is shaped and dimensioned so as to accommodate a fully opened laptop computer therein. The front panel is provided with a viewing window to enable viewing of the display portion of the laptop computer, whilst the keyboard portion thereof is located behind the remaining part of the front panel. The housing is further provided with support means adapted to sustain said housing in a substantially upright orientation, for example on a desktop or other surface.

This invention relates to a housing for a laptop computer. In particular, it relates to a housing which supports a laptop computer in its fully opened state, and sustains it in an upright orientation for viewing of its display.

The terms “laptop” and “laptop computer” are used herein to refer to a standard construction of portable personal computer, having a display portion hingedly connected along its lower edge to an upper edge of a keyboard portion. The position of the display portion may be varied to adopt a closed position (wherein the display portion overlies the keyboard portion), a working position (wherein the display portion is inclined at an angle of between about 90° and about 135° relative to the keyboard portion), and a fully opened position (wherein the display portion is arranged at substantially 180° relative to the keyboard portion).

The use of laptop computers has become widespread in recent years. In addition to their principal function as a tool for the travelling businessman, they are increasingly being used for entertainment purposes, such as playing computer games, watching DVDs, etc.

However, laptops are designed and built primarily as portable computers intended for close working by a single user. They are therefore not ideal for entertainment applications such as those described above, which typically involve more than one user or viewer, and wherein the user(s) or viewer(s) will usually be situated at a greater distance from the laptop display than is customary for normal computer usage. Similarly, in the business arena, laptop computers are impractical for displaying presentations etc. to a group of people.

The present invention seeks to provide means for converting a standard laptop computer into an entertainment centre or presentation unit, by enabling the laptop to be supported in its fully opened state (i.e. with the display portion at an angle of substantially 180° relative to the keyboard portion) and in an upright orientation. Viewing of the display by a number of people situated at a comfortable viewing distance from the laptop will thus be facilitated.

According to the present invention there is provided a housing for a laptop computer, comprising opposed front and rear panels defining a central cavity adapted to receive a fully opened laptop computer therein, a viewing window formed in said front panel to enable viewing of a display portion of a laptop computer when mounted therein, and support means adapted to sustain said housing in a substantially upright orientation.

The central cavity is provided with an opening at its upper edge, to permit the insertion of a fully opened laptop computer into said cavity. Retaining means are provided at or adjacent the lower edge of said cavity, for retaining said laptop computer in the cavity. The retaining means act to support the lower edge of the keyboard portion of a laptop computer mounted within the housing, and thereby ensure that the display portion of the laptop computer is aligned with the viewing window.

To enable the housing of the present invention to accommodate varying sizes of laptop computer, the retaining means are preferably adjustable, such that the vertical position of the laptop computer within the housing can be varied, thereby ensuring that the display portion of the laptop remains in alignment with the viewing window.

Most preferably, this is achieved by the provision of a plurality of aligned apertures on the front and rear panels of the housing, at either side thereof, and two or more complementary pins engageable with said apertures, and adapted to support the lower edge of a laptop computer mounted within the housing.

In order to permit the flow of air through the housing, it is much preferred that the lower edge of the central cavity, as well as its upper edge, is provided with an opening. The flow of air through the housing is desirable in order to avoid overheating of a laptop computer mounted therein.

The rear panel of the housing is preferably shaped and dimensioned so as in use to overlie substantially the whole of a fully opened laptop computer mounted within said housing, whilst the front panel is preferably shaped and dimensioned so as in use to overlie at least the keyboard portion of said laptop computer.

The viewing window may be formed either as a transparent screen in the portion of the front panel which in use overlies the laptop display portion, or alternatively may simply be formed as a cut-out portion of said housing, with the front panel in use overlying only the keyboard portion of the laptop.

The housing preferably further comprises securing means adapted to secure a laptop computer within the housing and hold it against the front panel. Air is thus allowed to circulate normally around the back of the laptop. Preferably, the securing means comprises a strap or bar adapted to hold the keyboard portion of a laptop computer against the front panel.

The support means may be in the form of one or more wall-mounting points provided on the rear panel of the housing, to enable the housing to be mounted on a wall. The or each wall-mounting point may be a standard hook and eye arrangement. Alternatively, or additionally, the support means may comprise one or more feet, provided along a lower edge of the housing, to enable the housing to stand upright on a desktop. The feet may desirably be removable and/or may be provided with extendable leg portions to enable the housing to be free-standing on a floor.

In order that a laptop mounted within the housing may be used with standard remote peripheral devices such keyboards, mice etc., the housing preferably further comprises one or more infra-red sensors adapted to receive infra-red signals from such peripheral remote devices, and connectors for connecting said infra-red sensors to a laptop computer mounted within said housing.

The housing preferably further comprises one or more speaker casings adapted to house one or more loudspeakers, for connection to a laptop computer when mounted within the housing. In a currently preferred embodiment of the present invention, a speaker casing is provided at each side of the central cavity, bridging the front and rear panels. It is much preferred that these speaker casings are provided adjacent the upper edge of the housing and extending substantially half the height of the housing. In this way, the display portion of a laptop mounted in the housing is flanked by loudspeakers to either side, thus enhancing the user's viewing experience.

In an alternative embodiment of housing according to the present invention, the front and rear panels are each provided with a hinge, extending across the housing adjacent the base of the speaker casing. The panels may thus be adjusted between a first extended position wherein the housing is adapted to receive a fully opened laptop computer, and a second compact position, wherein the housing is adapted to receive a closed laptop computer.

Alternatively, the front and rear panels, or lower portions thereof, may be adapted to achieve the same effect by being mounted for sliding motion in tracks or grooves provided in the speaker casings to either side of the central cavity.

The housing may be provided with a carrying handle, at or adjacent its upper edge, such that when the front and rear panels are in their second compact position, the housing may be used as a laptop carrying case.

In order that the present invention may be fully understood, preferred embodiments thereof will now be described in detail, though only by way of example, with reference to the accompanying drawings, in which:

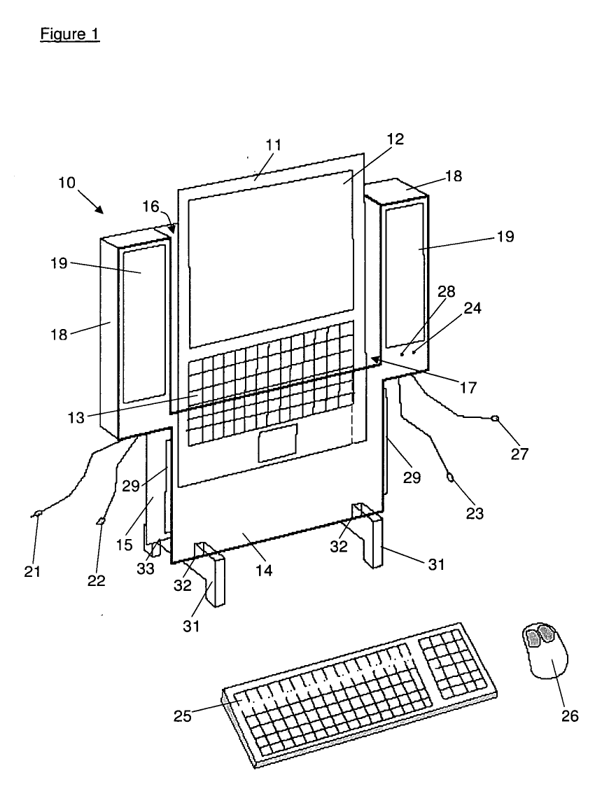

FIG. 1 shows a perspective front view of a housing according to a first embodiment of the present invention, having a laptop computer partially inserted into its central cavity;

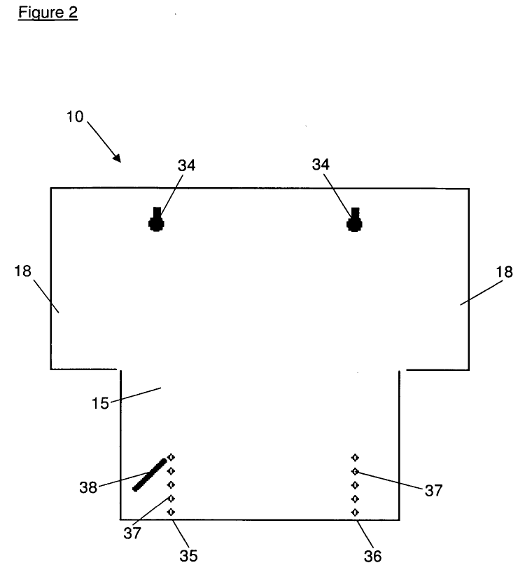

FIG. 2 shows a rear view of the housing of FIG. 1;

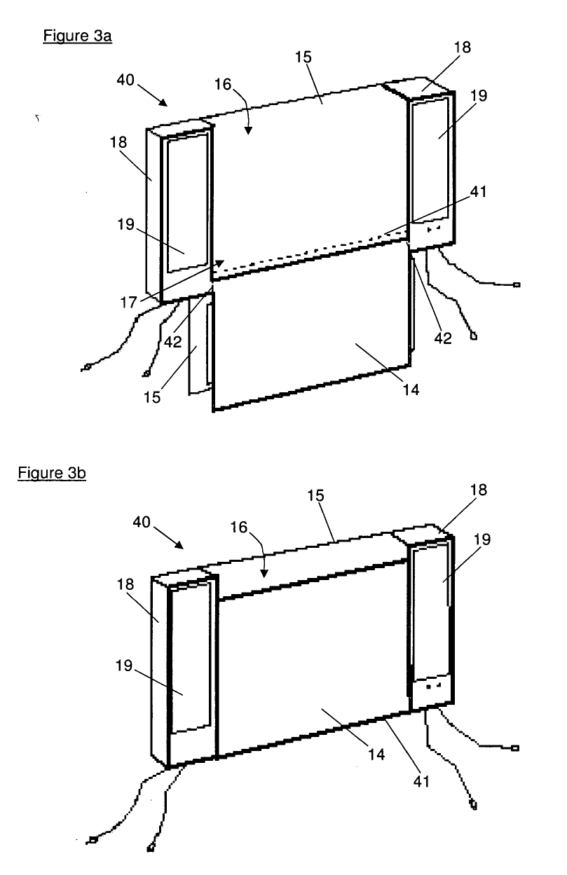

FIG. 3a shows a perspective front view of a housing according to a second embodiment of the present invention, in its extended position;

FIG. 3b shows a perspective front view of the housing of FIG. 3a, in its compact position; and

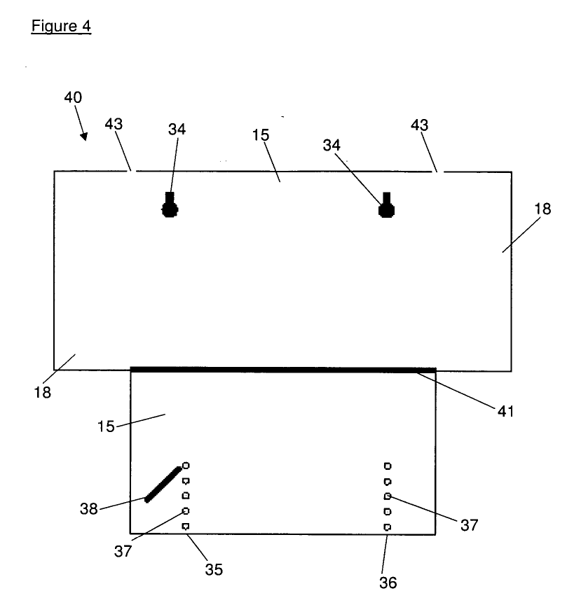

FIG. 4 shows a rear view of the housing of FIG. 3a.

Referring first to FIG. 1, there is shown a first embodiment of housing, generally indicated 10, for a laptop computer 11, having a display portion 12 and a keyboard portion 13. The laptop computer 11 is shown here in its fully opened position, and partially inserted into the housing 10.

The housing 10 comprises a front panel 14 and a rear panel 15, which together define a central cavity 16 for receiving the laptop computer 11. An upper part of the front panel 14 is cut away to form a viewing window 17. In use, this viewing window 17 will be aligned with the display portion 12 of the laptop 11, whilst the keyboard portion 13 will be located behind the remaining part of the front panel 14.

To either side of the viewing window 17 is provided a speaker casing 18, formed as an integral part of the housing 10, and bridging the front and rear panel 14, 15. A pair of loudspeakers 19 is mounted within the speaker casings 18, and audio and power connectors 21, 22 are provided, for connecting the laptop computer 11 to the loudspeakers 19.

A further connector 23 is provided, for connecting the laptop computer 11 to a sensor 24 adapted to receive infra-red signals from a remote cordless keyboard 25 and mouse 26. The housing 10 may additionally be provided with a built-in antenna (not shown) for receiving broadcast television signals, and an antenna connector 27 is provided to connect the laptop 11 thereto. An LED 28 indicates when the antenna is operational.

In order to secure the laptop 11 in a desired position, once it has been fully inserted into the cavity 16, the front panel 14 is provided with a pair of bars 29, one to either side. A strap (not shown) extends between the bars 29 and in use urges the keyboard portion 13 of the laptop 11 against the internal surface of the front panel 14, to ensure that air may flow freely through the cavity 16, around the back of the laptop 11.

To enable the housing 10 to stand upright on a desktop, or similar surface, a pair of removable feet 31 are provided along the lower edge of the housing 10. Each foot 31 has a pair of notches 32, 33, adapted to receive, respectively, the lower edges of the front and rear panels 14, 15.

As can be seen from FIG. 2, the rear panel 15 is also provided, on its external surface, with a pair of wall-mounting points 34, each in the form of an eye engageable with a complementary hook (not shown) attached to a wall on which the housing 10 is to be mounted.

Adjacent the lower edge of the rear panel 15, at either side thereof, are provided first and second sets 35, 36 of apertures 37. Each aperture 37 in each set 35, 36 extends through the rear panel 15, and is aligned with a corresponding aperture (not shown) on the front panel 14. A pin 38 is provided for each set of apertures 35, 36, and in use is inserted through a selected aperture 37 to engage with the corresponding aperture on the front panel 15, thus bridging the cavity 16 and providing a surface against which the lower edge of the keyboard portion 13 of the laptop 11 abuts. Clearly, the aperture 37 selected from the first set 35 must be at the same level above the lower edge of the housing 10 as the aperture 37 selected from the second set 36.

By moving the pins 38 between selected apertures 37, the effective depth of the cavity 16 can be varied so as to ensure that the display portion 12 of a laptop 11 mounted therewithin is aligned with the viewing window 17. The provision of a series of apertures 37 at different heights above the lower edge of the housing 10 thus enables the housing 10 to be used with laptops 11 of varying dimensions.

Referring now to FIG. 3a, there is shown an alternative embodiment of housing, generally indicated 40, for a laptop computer 11 as previously described. The housing 40 is essentially the same as the first embodiment of housing 10 described above with reference to FIGS. 1 and 2, except that the rear panel 15 is provided with a hinge 41 extending thereacross adjacent the base of the viewing window 17, whilst the front panel 14 is hingedly mounted to the speaker casings 18 at its upper edge 42. Alternatively, the inwardly-directed faces of the speaker casings 18 may each be provided with a groove (not shown) in which the front panel 14 is slidable. As can best be seen from FIG. 4, the hinge 41 effectively bi-sects the rear panel 15 adjacent the base of the speaker casings 18.

By rotating the front and rear panels 14, 15 about their respective hinges 42, 41, (or by sliding the front panel 14 in its groove) the housing 40 can be varied between the extended position shown in FIG. 3a and the compact position shown in FIG. 3b. In this compact position, the housing 40 is arranged to receive a closed laptop computer 11, and may additionally be provided with a handle (not shown) in order to function as a carrying case for a laptop computer 11. Referring again to FIG. 4, the upper edge of the housing 40 may be provided with handle fixing points 43 for this purpose.

1. A housing for a laptop computer, comprising opposed front and rear panels defining a central cavity adapted to receive a fully opened laptop computer therein, a viewing window formed in said front panel to enable viewing of a display portion of a laptop computer when mounted therein, and support means adapted to sustain said housing in a substantially upright orientation.

2. A housing as claimed in claim 1, wherein the central cavity has an opening at its upper edge, to permit the insertion of a fully opened laptop computer into said cavity, and retaining means provided at or adjacent its lower edge, for retaining said laptop computer in the cavity, with the display means of the laptop computer aligned with the viewing window.

3. A housing as claimed in claim 2, wherein the retaining means are adjustable so in use as to vary the position of a laptop computer relative to the viewing window, thereby to enable said housing to accommodate varying sizes of laptop computer.

4. A housing as claimed in claim 3, wherein the adjustable retaining means comprises a plurality of aligned apertures provided on the front and rear panels at either side of the housing, and two or more complementary pins engageable with said apertures, and adapted to support the lower edge of a laptop computer mounted within the housing.

5. A housing as claimed claim in claim 2, wherein the central cavity has a further opening at its lower edge to permit the flow of air through the housing.

6. A housing as claimed in claim 1, wherein the rear panel is shaped and dimensioned so as in use to overlie substantially the whole of a fully opened laptop computer mounted within said housing, and the front panel is shaped and dimensioned so as in use to overlie at least the keyboard portion of said laptop computer.

7. A housing as claimed in claim 8, wherein the front panel is shaped and dimensioned so as in use to overlie only the keyboard portion of a fully opened laptop computer mounted within said housing, the viewing window being formed as a cut-out portion of said housing, which in use overlies the display portion of said laptop computer.

8. A housing as claimed in claim 6, wherein the front panel is shaped and dimensioned so as in use to overlie substantially the whole of a fully opened laptop computer mounted within said housing, an upper portion of said front panel, which in use overlies the display portion of said laptop computer, being provided with a transparent screen thereby to form the viewing window.

9. A housing as claimed in claim 1, further comprising securing means adapted to secure a laptop computer within the housing such that said laptop computer is held against the front panel so as to allow air to circulate around the back of said laptop computer.

10. A housing as claimed in claim 9, wherein the securing means comprises a strap or bar adapted to hold the keyboard portion of a laptop computer against the front panel.

11. A housing as claimed in claim 1, further comprising one or more speaker casings.

12. A housing as claimed in claim 11, wherein the or each speaker casing further comprises a loudspeaker mounted therein, and one or more connectors for connecting said loudspeaker(s) to a laptop computer, when mounted in said housing.

13. A housing as claimed in claim 11, wherein a speaker casing is provided at each side of the central cavity, bridging said front and rear panels.

14. A housing as claimed in claim 13, wherein each said speaker casing is provided adjacent the upper edge of the housing and extends substantially half the height of the housing.

15. A housing as claimed in claim 14, wherein the front and rear panels each further comprise a hinge, extending across the housing adjacent the base of the speaker casing, by means of which the panels may be adjusted between a first extended position wherein the housing is adapted to receive a fully opened laptop computer, and a second compact position, wherein the housing is adapted to receive a closed laptop computer.

16. A housing as claimed in claim 15, wherein the housing further comprises a carrying handle, provided at or adjacent its upper edge, such that when the front and rear panels are in their second compact position, the housing may be used as a laptop carrying case.

17. A housing as claimed in claim 1, wherein the support means comprises one or more wall-mounting points provided on the rear panel of the housing, to enable the housing to be mounted on a wall.

18. A housing as claimed in claim 17, wherein the or each wall-mounting point comprises a hook and eye arrangement.

19. A housing as claimed in claim 1, wherein the support means comprises one or more feet, provided along a lower edge of the housing, to enable the housing to stand upright on a desktop.

20. A housing as claimed claim 1, having first support means comprising a hook or bracket provided on the rear panel of the housing, to enable the housing to be mounted on a wall, and second support means comprising one or more feet provided along a lower edge of the housing, to enable the housing to stand upright on a desktop.

21. A housing as claimed in claim 1, further comprising one or more infra-red sensors adapted to receive infra-red signals from a remote mouse and/or keyboard, and connectors for connecting said infra-red sensors to a laptop computer mounted within said housing.
